(19) United States
(12) Patent Application Publication
(10) Pub. No.: US 2026/0003928 A1
(43) Pub. Date: Jan. 1, 2026

(54) SYSTEM AND METHOD FOR DYNAMICALLY LOADING USER INTERFACE COMPONENTS

(71) Applicant: DIGITAL FIRST HOLDINGS LLC, ATLANTA, GA (US)

(72) Inventors: Michael TABB, Atlanta, GA (US); Nagaprakash Sekharaiah HIREMATH, Atlanta, GA (US)

(21) Appl. No.: 18/758,636

(22) Filed: Jun. 28, 2024

(51) Int. Cl. G06F 16/958; G06F 16/957

(52) U.S. Cl. CPC G06F 16/986; G06F 16/9577

(57) ABSTRACT

A computer-implemented system and method dynamically loads user interface components. A request for a web page is received at a web server coupled to a wide area network from a remote client of a user. An initial user interface for the requested web page, having an associated document object model (DOM), is generated at the web server. An extension registry is initialized and then it is determined that the requested web page includes an extension. The extension registry is queried to identify a storage location for an extension module associated with the extension. The extension module is loaded from the storage location. The extension module implements a user interface component. The extension module is inserted into the DOM. The web page, including the DOM, is provided by the web server to the remote client of the user.

### FIELD

This disclosure relates generally to a system and method for dynamically loading user interface components, and more particularly to a system and method in which a server-driven user interface uses an extension registry to manage and dynamically load user interface components.

### BACKGROUND

Many different types of companies develop and provide server-based software applications or platforms (white label solutions) which re-branded for use by third-parties with their customers. For example, larger banks, digital commerce providers, and fintech companies may provide white label solutions for services like banking applications, payment processing systems, and/or trading platforms to smaller financial institutions in order to allow them to offer competitive services without extensive development costs. These providers may offer such services to numerous customers via a common server based on a white label user interface (UI) web application. When using a white label UI web application, all of the third-parties (tenants) use the same code base. One issue that can arise in this context is that fetching and integrating customer-specific components is difficult due to a need for contextual information in order to fetch and load the correct artifacts.

The present disclosure describes a technical solution that solves the above-noted technical problem.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system according to an aspect of the current disclosure;

FIG. 2 is a schematic block diagram of an example computing system for use in the system of the current disclosure;

FIG. 3 is a flow diagram of the system of the current disclosure; and

FIG. 4 is a flowchart of a method of operation of the system of the current disclosure.

### DETAILED DESCRIPTION

In the present disclosure, like reference numbers refer to like elements throughout the drawings, which illustrate various exemplary embodiments of the present disclosure.

A server-side user interface (UI) web application is a type of web application architecture where most of the UI rendering and processing logic is handled on the remote web server rather than the client (browser). A server-side UI web application may serve multiple tenants (e.g., clients, customers, organizations, etc.) by structuring the application in a way that allows each of the different tenants (or their customers) to access and interact with their own isolated instances of the application. Furthermore, this type of application may be configured as a white label application so that each of the tenants can customize the appearance (e.g., branding, logos, colors) of their user interface while using the same underlying application code.

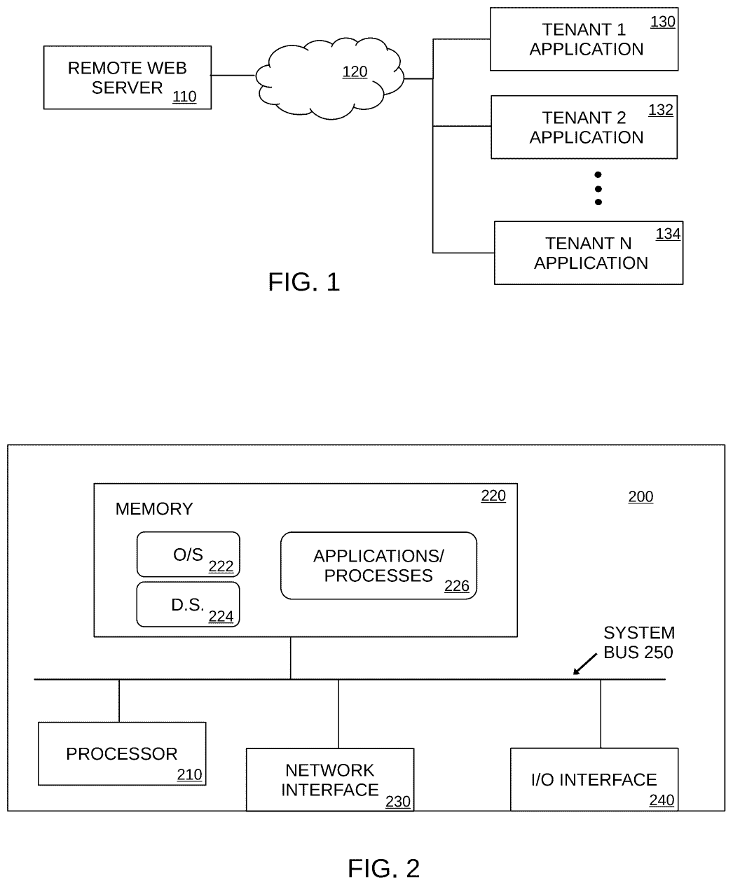

Referring now to FIG. 1, a remotely located web server 110 is shown coupled to a network 120 that may be a wide area network such as the Internet. As known in the art, the web server 110 consists of computer software and underlying hardware (as discussed with respect to FIGS. 2 to 4) that accepts user requests over the network 120 via, for example, the Hypertext Transfer Protocol (HTTP) or its secure variant HTTPS. In the context of the instant disclosure, the web server 110 operates a multi-tenant server-side user interface (UI) web application. A user agent, commonly a web browser or a mobile device application (app), initiates communication with the web server 110 by making a request for a web page or other resource using HTTP, and the web server 110 responds with the requested content/resource (or an error message) particular to the tenant associated with such request. In many cases, a provider may use a web server to provide web applications (organized groups of web pages) for multiple customers that rely on such sites to provide online services (e.g., online banking). In many cases, web server 110 may be configured to provide services to a number (e.g., N) of different tenants, so that an end user of a first tenant (e.g., a first bank) may be able to access a Tenant 1 Application 130 via a dedicated application or web browser on a client device (computer, phone, tablet, etc.), an end user of a second tenant (e.g., a second bank) may be able to access a Tenant 2 Application 132 via a dedicated application or web browser on a client device, and an end user of an Nth tenant (e.g., an Nth bank) may be able to access a Tenant N Application 134 via a dedicated application or web browser on a client device via network 120 using appropriate requests particular to the associated tenant and browser or application.

In FIG. 1, a single web server 110 is shown for providing the content necessary for generating the UI information and content to the applications 130, 132, 134 operating remotely. In many cases, the content may be cached on a geographically distributed network of servers and data centers that work together to provide such content, e.g., as a content delivery network (CDN).

FIG. 2 is a schematic block diagram of an example computing system or device 200 that may be used with one or more embodiments described herein, e.g., as the web server 110 shown in FIG. 1 or the remote computer (or web-enabled device) mentioned above. Device 200 may include at least one processor 210, a memory 220, one or more network interfaces 230 (e.g., wired, wireless, etc.), and one or more input/output (I/O) interfaces 240, which may be interconnected by a system bus 250. The network interface(s) 230 and the I/O interface(s) 240 are referred to in the singular hereinafter for ease of explanation. The network interface 230 contains the necessary circuitry for communicating data over links coupled to the network 120. The network interface 230 may be configured to transmit and/or receive data using a variety of different communication protocols. Note, further, that configuration of device 200 shown in FIG. 2 is merely illustrative, and device 200 may have multiple types of network connections via multiple network interfaces 230, e.g., wireless and wired/physical connections.

The memory 220 may include a plurality of storage locations that are addressable by the processor 210 and the network interface 230 for storing software programs and data structures associated with the embodiments described herein. The parts of memory 220 that store software programs, including any operating system, may be a non-transitory computer-readable storage medium. The processor 210 may comprise hardware elements or hardware logic adapted to execute software programs and manipulate the data structures 224. An operating system 222, portions of which are typically resident in memory 220 and executed by the processor 210, functionally organizes the device 200 by, among other things, invoking operations in support of software processes and/or services executing on the device 200. These software processes and/or services may include one or more applications/processes 226.

The I/O interface 240 may not be present in all embodiments (e.g., when the device 200 is a cloud-based server), but when present, typically includes a user interface (UI) that has an input device, such as an alpha-numeric keypad (e.g., a keyboard) for inputting alpha-numeric and other information, a pointing device (e.g., a mouse, a trackball, stylus, or cursor direction keys), a touchscreen, a microphone, a camera, and so forth.

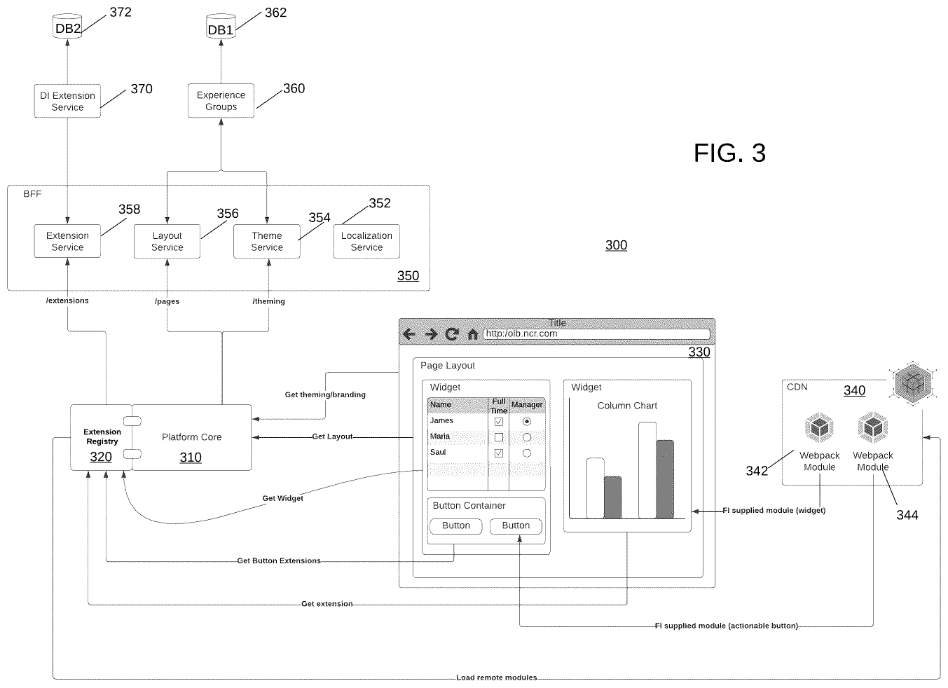

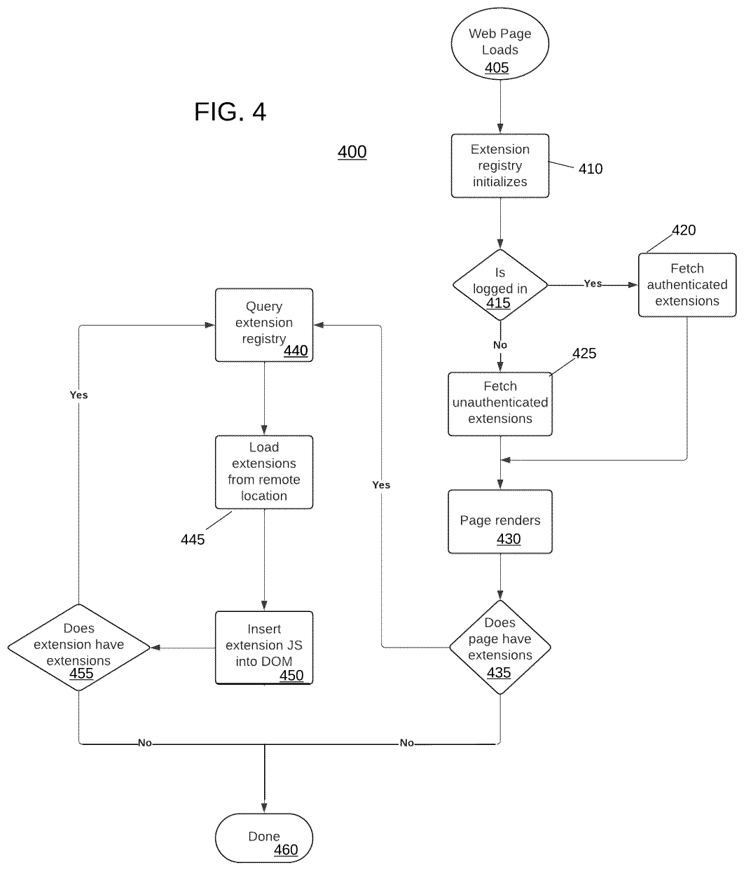

A white label server-side user interface (UI) web application is difficult to customize with extensions because of limitations in existing software solutions. The system and method of the current disclosure expand the framework of existing software solutions to provide an extension registry which allows a tenant, such as a financial institution, to build their own dynamic UI components that conform to an extension point schema and to deploy these components to a content delivery network (CDN). An extension record is created with the schema details and the location of the deployed extension module. As explained with respect to FIGS. 3 and 4, the extension registry is then used to fetch, query, and load the dynamic components for the extension. The extensions may be custom widgets or components that add or modify UI components such as buttons, forms, tables, and charts to meet specific functional needs or design preferences. In addition, the extensions may provide integration with an external application programming interface (API) or service to allow the UI to fetch data or perform specific actions via such API or service. Some examples of extensions include: (1) a credit score widget may be added to a financial institution home page that sits alongside other widgets like account and transaction widgets; (2) a loan application micro app that occupies an entire page and has a navigation item, e.g., an atomic application (one that is modular, self-contained, and independently deployable) that operates independently of the core main application; (3) a dispute transaction button operating as a small nano app (one that is very small and designed to perform a specific task or function) that can add an ability to dispute a transaction within the context of the transaction; (4) an account data provider function or class to provide access to user account information hosted externally (e.g., by a linked third party provider); and (5) a promotion data provider function or class to provide access to promotion card content from external sources (useful for tenants that employ separate marketing systems like Salesforce).

Referring now to FIG. 3, a flow diagram 300 shows the operation of the system of the present disclosure. The platform core 310 corresponds to the white-labelled server-side user interface (UI) web application running on a remote server (e.g., web server 110) in FIG. 1. The platform core 310 operates as the frontend client, e.g., on a first server, and is coupled to a separate backend for frontend (BFF) server 350. The BFF 350 is part of an architectural pattern where each frontend client (e.g., web application, mobile app) has its own dedicated backend server. This allows the backend to provide optimized data and services that are directly relevant to the requirements of the frontend client. When a client device (e.g., a remote computer, phone or tablet) requests a web page of a tenant, the platform core 310 provides theming/branding and layout information for the web page 330 via a layout service 356 and a theme service 354 on the BFF 350. The layout service 356 and the theme service 354 are coupled to experience groups 360 stored on a memory 362 (e.g., a non-volatile memory like a hard disk or solid state drive organized as a database). The localization service 352 is used to identify the particular tenant among the various tenants in a multi-tenant architecture so that the appropriate theming/branding and layout information can be retrieved. The particular tenant may be identified via the URL initially provided by the client device, for example.

Conventional white label server-side user interface (UI) web applications are not easily configured to dynamically provide extensions to a particular tenant among a multi-tenant architecture. The system and method of the current disclosure overcomes that problem by adding an extension registry 320 that operates in conjunction with the program core 310. The extension registry 320 is used to fetch customer extensions via an extension service 358 in the BFF 350. The extension service 358 is linked to a DI extension service 370 and, in turn, a memory 372 (e.g., a non-volatile memory like a hard disk or solid state drive organized as a database) for storing the tenant extension records. The tenant extension records from the BFF 350 describe the particular extension and the associated extension point, all details of that extension point schema, and the remote location where the extension artifacts for the particular extension are publicly available. The remote location may be, for example, a location within CDN 340 where the Webpack modules 342, 344 are stored. The extension registry 320 is then responsible for loading those remote extension artifacts dynamically and at runtime when queried in order to augment the white label UI for the associated tenant with tenant-supplied extensions.

This system and method of the present disclosure makes use of Module Federation, a technology used for micro front ends. Module Federation is a feature introduced in Webpack 5 that allows separate JavaScript builds (“modules”) to work together at runtime. A micro front end is a design pattern used in frontend web development where a frontend application is decomposed into smaller, loosely-coupled, and independently deployable modules. The limitation of this technology is that it still requires a static configuration that needs to be supplied at boot-up time and does not consider a dynamic environment where the application must query and load components in a dynamic fashion based upon the needs of a particular tenant. Until now, Module Federation did not incorporate the extension point/extension relationship of the system and method of the present disclosure. By adding extension points, the system and method of the present disclosure provides for context around the extension and allows for the addition of further filtering/placement/behavior to an added web component. In operation, the UI web application inserts extension point code which is the insertion point for extensions. The extension point is defined with a schema describing what the developer is providing, which can be anything from a UI component to a non-UI class or function. The extension point code to queries the extension registry 320 which uses the tenant context and loads and uses the corresponding components at runtime.

The system and method of the present disclosure allows tenants such as financial institutions to add value and capabilities in line with the application for a unified user experience for their end customers. The granularity of the extensions can vary widely, from small atomic UI/non-functional components up to whole pages. Without the technical features added by way of the present disclosure, there is no way to provide additional services and capabilities above a white label UI via a conventional white-label server-side user interface (UI) web application that a tenant, e.g., financial institution, would like to offer via a web interface or mobile application.

The operation of the system and method of the present disclosure is shown in the flowchart 400 shown in FIG. 4. First, the platform core 310 receives a message from a user requesting a web page for a particular tenant at step 405 and generates the white label version of the requested web page with the appropriate layout and theming/branding for that tenant. The extension registry 320 loads at step 410, and it is then determined at step 415 if the user is logged in (has presented appropriate credentials). If the user is logged in, the extension registry 320 fetches any authenticated extensions from the extension service 358 at step 420 (e.g., extensions appropriate to the account of that user at the tenant institution). If the user is not logged in, the extension registry 320 fetches any unauthenticated extensions from the extension service 358 at step 425 (e.g., extensions appropriate for a new user of the tenant institution). Thereafter, the platform core 310 renders the web page at step 430 and determines if the web page has extensions at step 435. If the web page does not have extensions, the web page is considered complete and processing halts at step 460 until a further request is received. If the web page does have extensions, the extension registry 358 is queried at step 440, and based on the results received from the query, the extension module (e.g., a Webpack module 342 or 344 in JavaScript) is loaded from a remote location at step 445. The extension module is inserted into the Document Object Model (DOM) at step 450 to provide the functionality necessary to the current web page. The DOM provides a structured representation of web documents and a standardized way for scripts to access, manipulate, and interact with the content and structure of a web page dynamically At step 455, it is determined whether there is an extension to the current extension. If not, the web page is considered complete and processing halts at step 460 until a further request is received. If there is an extension to the current extension, processing moves back to steps 440, 445, and 450 to repeat the process for the new extension. Processing continues until there are no more extensions of extensions, and the web page is considered complete and processing halts at step 460 until a further request is received.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A computer-implemented method for dynamically loading user interface components, comprising:
receiving, at a web server coupled to a wide area network, a request for a web page from a remote client of a user;
generating, at the web server, an initial user interface for the requested web page, the requested web page having an associated document object model (DOM);
initializing, at the web server, an extension registry and determining that the requested web page includes an extension;
querying, at the web server, the extension registry to identify a storage location for an extension module associated with the extension;
loading, at the web server, the extension module from the storage location, the extension module for implementing a user interface component;
inserting, at the web server, the extension module into the DOM; and
providing, by the web server, the web page, including the DOM, to the remote client of the user.

2. The computer-implemented method of claim 1, comprising:
after inserting the extension module into the DOM, determining, at the web server, that the extension has a further extension;
querying, at the web server, the extension registry to identify a storage location for a further extension module associated with the further extension;
loading, at the web server, the further extension module from the storage location, the further extension module for implementing a user interface component; and
inserting, at the web server, the further extension module into the DOM.

3. The computer-implemented method of claim 1, wherein the requested web page is for a particular tenant among a plurality of tenants.

4. The computer-implemented method of claim 1, wherein the storage location of the extension module is located remotely from the web server.

5. The computer-implemented method of claim 1, wherein the storage location of the extension module is located within a content delivery network (CDN).

6. The computer-implemented method of claim 3, wherein the extension module is a widget associated with the particular tenant.

7. The computer-implemented method of claim 3, wherein the extension module is a micro app associated with the particular tenant.

8. The computer-implemented method of claim 7, wherein the tenant is a financial institution, and the micro app provides a loan application page.

9. The computer-implemented method of claim 3, wherein the extension module is a data provider function associated with the particular tenant used to obtain data about an account associated with the user from a remote source.

10. The computer-implemented method of claim 9, wherein the tenant is a financial institution, and the data provider function obtains data about a financial account of the user from the remote source.

11. A system having web server coupled to a wide area network for supplying web pages based on user requests via the wide area network, the web page having dynamically loaded user interface components, the web server having a processor and a non-transitory computer-readable storage medium, the non-transitory computer-readable storage medium including executable instructions that, when executed by the processor, cause the processor to:
receive a request for a web page from a remote client of a user;
generate an initial user interface for the requested web page, the requested web page having an associated document object model (DOM);
initialize an extension registry and determine that the requested web page includes an extension;
query the extension registry to identify a storage location for an extension module associated with the extension;
load the extension module from the storage location, the extension module for implementing a user interface component;
insert the extension module into the DOM; and
provide the web page, including the DOM, to the remote client of the user.

12. The system of claim 11, wherein the non-transitory computer-readable storage medium includes executable instructions that, when executed by the processor, cause the processor to:
after inserting the extension module into the DOM, determine that the extension has a further extension;
query the extension registry to identify a storage location for a further extension module associated with the further extension;
load the further extension module from the storage location, the further extension module for implementing a user interface component; and
insert the further extension module into the DOM.

13. The system of claim 11, wherein the requested web page is for a particular tenant among a plurality of tenants.

14. The system of claim 11, wherein the storage location of the extension module is located remotely from the web server.

15. The system of claim 11, wherein the storage location of the extension module is located within a content delivery network (CDN).

16. The system of claim 13, wherein the extension module is a widget associated with the particular tenant.

17. The system of claim 13, wherein the extension module is a micro app associated with the particular tenant.

18. The system of claim 17, wherein the tenant is a financial institution and the micro app provides a loan application page.

19. The system of claim 13, wherein the extension module is a data provider function associated with the particular tenant used to obtain data about an account associated with the user from a remote source.

20. The system of claim 19, wherein the tenant is a financial institution, and the data provider function obtains data about a financial account of the user from the remote source.
